(19) United States
(12) Patent Application Publication
(10) Pub. No.: US 2003/0036982 A1
(43) Pub. Date: Feb. 20, 2003

(54) System and method for checking import and export cargo

(76) Inventors: Ying Tang, Shenzhen (CN); Chun-Chih Lee, Tao-Yuan (TW); Sheng-Chi Luo, Taipei (TW); Wenbo Mao, Shenzhen (TW)

Correspondence Address: Wei Te (Joseph) Chung, Foxconn International, Inc., 1650 Memorex Drive, Santa Clara, CA, 95050, US

(21) Appl. No.: 10/078,898

(22) Filed: Feb. 19, 2002

(30) Foreign Application Priority Data
Aug. 17, 2001 (TW) 90120210

(51) Int. Cl. G06F 17/60

(52) U.S. Cl. 705/28

(57) ABSTRACT

A system (1) and method for checking import and export cargo by performing electronic data exchange with an external system (3) via a communications network (2). The system comprises a server (10) and a plurality of platform computers (20) electrically connected to the server (10). The server (10) has a database (101) and an interactive interface (203) for facilitating inspectors checking cargo. The database stores accounts and passwords of the inspectors, information obtained from the external system, and check records and inspection records of cargo. Each platform computer (20) is installed with the interactive interface (203) for guiding an inspector to check cargo. A card reader (202) is electrically connected to each platform computer (20) for identifying the inspectors. A display board (40) is electrically connected to each platform computer (20) via a corresponding serial communication device (30) for displaying loading and unloading information on cargo.

### BACKGROUND OF THE INVENTION

1. Field of the Invention

The present invention relates to a system and method for checking import and export cargo in transit to and from a manufacturer, and particularly to a system and method for remotely located departments of the manufacturer and for a government customs organ to track import and export cargo.

2. Description of Related Art

With rapid development of manufacturing industry worldwide, more manufacturers are facing the challenge of satisfying customers' orders at the lowest cost of inventory. A typical large manufacturer receives goods from numerous overseas suppliers. However, it is difficult for the suppliers to deliver the goods in time, due in large part to many checking procedures required by a government's customs organ and by the manufacturer itself.

Moreover, due to increasing economic globalization, more manufacturers are procuring required materials from overseas and selling final products overseas after manufacturing. The required materials are sent from overseas to a bonded factory and manufactured into the final product in the bonded factory. These required materials need to be checked by customs and relevant departments of the manufacturer before they are sent to the bonded factory. Similarly, the final products need to be checked by customs and relevant departments of the manufacturer before they are sent abroad. A coordinated mechanism for both customs and a manufacturer to check incoming materials and outgoing products is required.

U.S. Pat. No. 6,148,291 discloses container and inventory monitoring methods and systems providing detailed logistical control of containers, shipping racks and resident and in-transit inventory. The methods and systems create and maintain accurate real-time records of the location, movement and load status of containers, racks and inventory within the facility boundaries and between facilities such as factories, assembly plants, warehouses, shipping yards and freight switching facilities. Detailed data on container switching, unloading and loading activity is recorded and archived. The system includes a processing center for receiving and processing container-related data, a container monitoring system database, a virtual inventory database, one or more container data input terminals which may be local or remotely located from the system, a monitor, communications links, remote container data transceivers, and one or more printers for producing hard copy reports of container data.

In one application of the system, one or more container data input terminals and monitors is located at a gate or gates of a premises for input of data acquired from incoming and outgoing containers of the system. Many different types of data input devices can be used to input carrier and container data to the system. An operator at the gate can manually input the data as vehicles carrying containers arrive. A driver of a vehicle can communicate with an operator at the gate using a hand-held radio. The vehicles are equipped with remote terminal reception and display devices that allow data input and provide data receipt and real-time display of container locations. The system is interoperable with other computing systems such as management information systems (MISs). The MISs may be those of a facility to which containers are delivered, of an end customer, and of a container carrier business. The system is commonly linked with a plant or customer management information system and container carrier management information system for cross exchange of container and inventory data.

The container and inventory monitoring methods and systems of U.S. Pat. No. 6,148,291 can effectively monitor incoming and outgoing containers of a particular premises. However, this patent does not address means for customs to accurately check the cargo carried by vehicles. Further, it does not provide means for relevant departments of a manufacturer that are remote from the site to monitor the checking operation. Accordingly, a comprehensive system and method for checking import and export cargo is desired.

### SUMMARY OF THE INVENTION

An object of the present invention is to provide a system and method for checking import and export cargo being delivered to and dispatched from a factory.

Another object of the present invention is to provide a system and method for checking import and export cargo which allows users to track import and export cargo in real time and to check and query import and export cargo records in real time.

A further object of the present invention is to provide a system and method for arranging and monitoring checking of import and export cargo from remote sites via a communications network.

A still further object of the present invention is to provide a system and method for checking import and export cargo whereby a government customs organ can send instructions regarding inspection from a remote site to on-site inspectors via a communications network.

In accordance with a first aspect of the present invention, a system for checking import and export cargo is connected to an external system via a communications network for performing electronic data exchange. The system for checking import and export cargo comprises: (a) a server having a database and an interactive interface for facilitating inspectors checking cargo, wherein the database is used for storing essential information including identities of users who are authorized to access the database, user accounts and passwords, departments to which users belong, docks where cargo is to be loaded and unloaded, information obtained from the external system, and check records/inspection records of cargo; (b) a plurality of platform computers each installed with a same interactive interface installed in the server for guiding an inspector to check cargo; (c) a card reader electrically connected to each platform computer for identifying the inspectors; (d) a serial communication device electrically connected to each platform computer; and (e) a display board electrically connected to each platform computer via a corresponding serial communication device, for displaying loading and unloading information on cargo.

In accordance with a second aspect of the present invention, a method for checking import cargo is provided. The method comprises the steps of: (a) applying to customs with a customs import declaration; (b) conducting a customs inspection based on a customs import declaration with lock notice; (c) obtaining a delivery requisition note; (d) showing content of cargo on a display board based on the delivery requisition note; (e) checking the import cargo; and (f) producing a check record.

In accordance with a third aspect of the present invention, an export cargo checking process for checking export cargo is provided. The method comprises the steps of: (a) obtaining a shipment list; (b) showing content of cargo on a display board based on the shipment list; (c) checking the export cargo; (d) applying to customs with a customs export declaration; and (e) producing an inspection record. Other objects and advantages of the present invention will become more apparent from the following detailed description and the drawings, and may be learned by practice of the invention.

### BRIEF DESCRIPTION OF THE DRAWINGS

FIG. 1 is a schematic diagram of a system for checking import and export cargo in accordance with the present invention;

FIG. 2 is a schematic diagram showing several external systems cooperating with the system of the prevent invention;

FIG. 3 is a schematic diagram showing data exchange between a database of the system of the present invention and the external systems of FIG. 2;

FIG. 4A is a schematic diagram of an interactive interface of the system of FIG. 1;

FIG. 4B is a schematic diagram of a cargo query module of the interactive interface of FIG. 4A;

FIG. 4C is a schematic diagram of a basic data maintaining module of the interactive interface of FIG. 4A;

FIGS. 5A and 5B are respective flowcharts of an import cargo checking procedure and an export cargo checking procedure both of the present invention;

FIG. 6 is a detailed flowchart of the import cargo checking procedure of FIG. 5A, including role players; and

FIG. 7 is a detailed flowchart of the export cargo checking procedure of FIG. 5B, including role players.

### DETAILED DESCRIPTION OF THE INVENTION

Reference will now be made to the drawing figures to describe the present invention in detail.

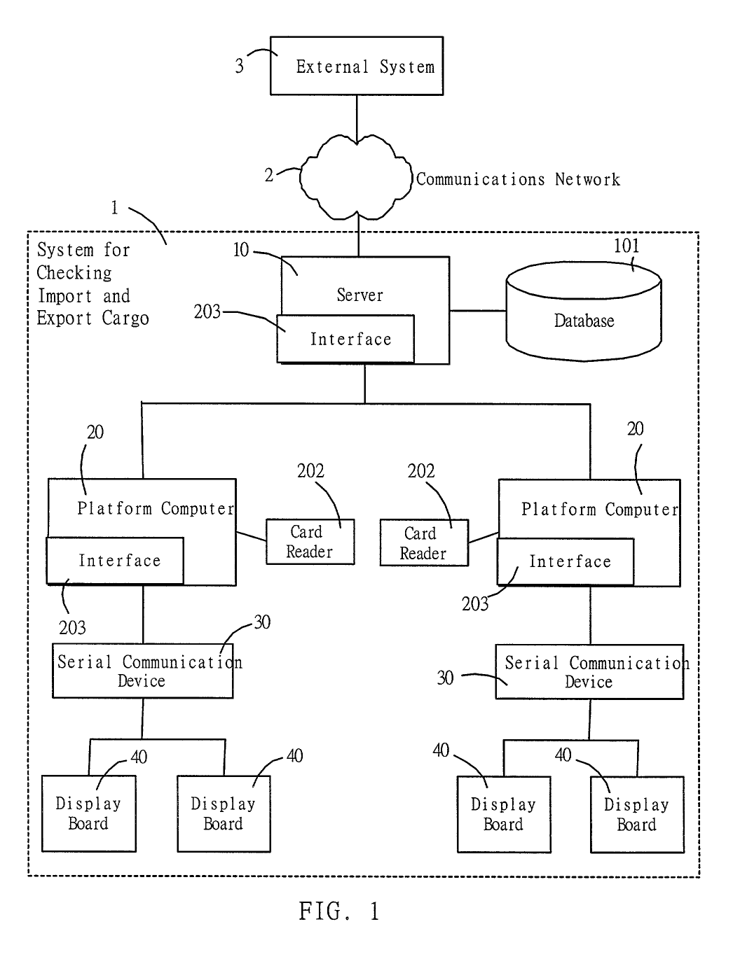

FIG. 1 shows a system 1 for checking import and export cargo in accordance with the present invention. The system 1 is connected to an external system 3 via a communications network 2 for electronic data interchange. The system 1 comprises a server 10 having a database 101 and an interactive interface 203, a plurality of platform computers 20 (only two shown) each having an interactive interface 203 and electrically connected to the server 10, a plurality of serial communication devices 30 each electrically connected to a corresponding platform computer 20, and a plurality of display boards 40 indirectly connected to respective platform computers 20 via one corresponding serial communication device 30. Users such as an administrator of the whole system 1, production department managers, factory inspectors and customs inspectors may be assigned with different authorities to access parts of or all information contained in the database 101. The database 101 is used for storing essential information including user accounts and passwords, information on all departments which employ the factory inspectors, information on docks where cargo is to be loaded and unloaded, information from the external system 3, and check records of import cargo and inspection records of export cargo. Each interactive interface 203 has a keyboard (not shown) or a touch panel (not shown) to enable factory inspectors to check cargo, access the information stored in the database 101, and control the display boards 40. A card reader 202 is used for identification of inspectors who operate the platform computer 20. Each serial communication device 30 is preferably the well-known RS232/RS485. Each display board 40 displays information on cargo according to the essential information stored in the database 101. The external system 3 is hereinafter explained only in brief, because an infrastructure and characteristics thereof are well known to those skilled in the art.

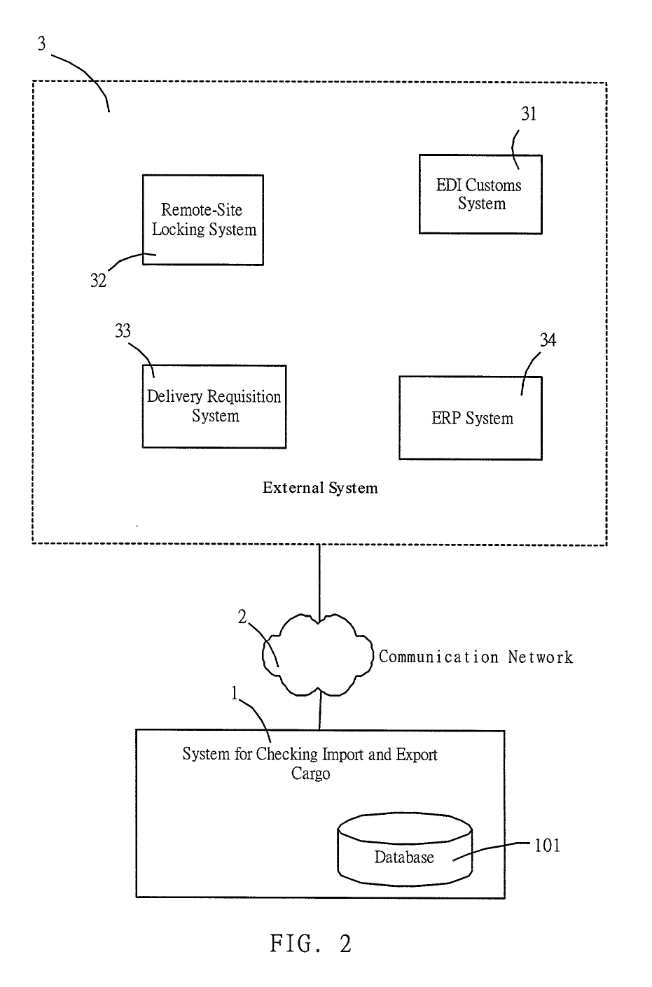

Referring to FIG. 2, the external system 3 comprises an electronic data interchange (EDI) customs system 31 for transmitting electronic data on customs formalities, a remote-site locking system 32 for transmitting electronic data from a government's customs organ (“customs”) to the system 1 after customs formalities are completed, a delivery requisition system 33 for managing incoming cargo receipt, and an enterprise resource planning (ERP) system 34 for managing outgoing cargo shipment. Each system 31, 32, 33, 34 of the external system 3 is connected to the system 1 via the communications network 2 for electronic data exchange.

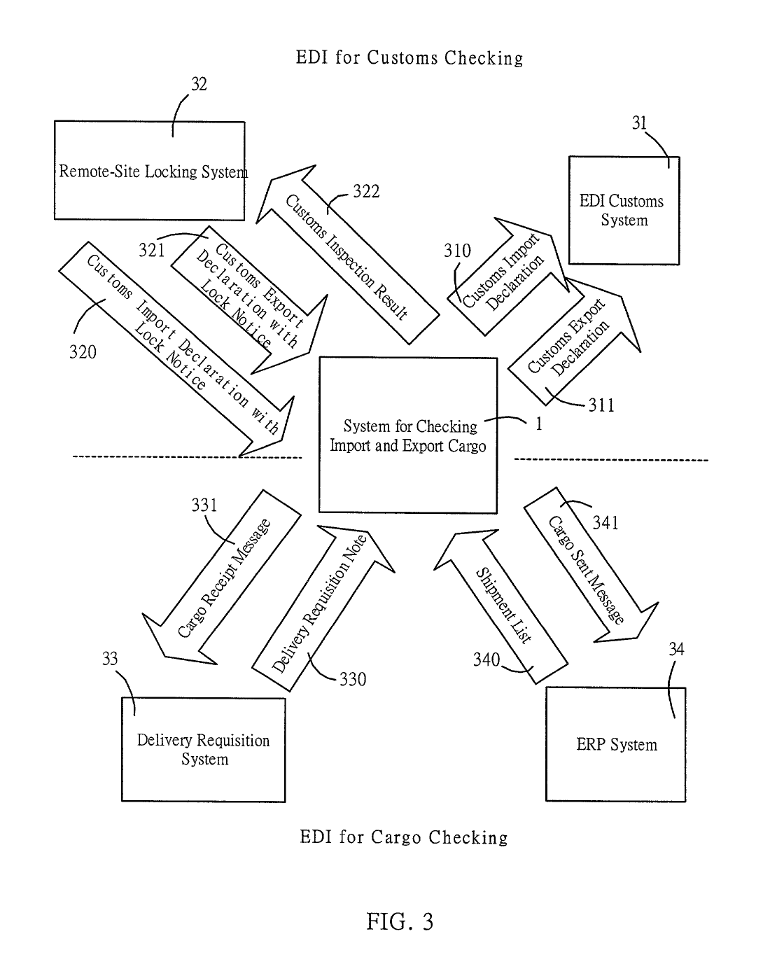

FIG. 3 is a schematic diagram of data exchange between the systems of the external system 3 and the database 101 of the system 1 of the present invention. Data exchange between the two systems 1, 3 facilitates completion of customs inspection and formalities regarding import and export cargo. Data exchange between the two systems 1, 3 also facilitates checking of content of cargo and quality control checking. At the commencement of importation or exportation, a customs import declaration 310 or a customs export declaration 311 is sent from the system 1 to the EDI customs system 31 which is located at a premises of customs. The declaration 310, 311 comprises an application for customs formalities. After finishing customs formalities, customs decides whether or not to inspect the cargo, and generates a corresponding lock notice (not shown) on the remote-site locking system 32. There are two modes of lock notices including lock mode and unlock mode. Lock mode is generated when customs decides to inspect the cargo. Unlock mode is generated when customs decides not to inspect the cargo. The lock notice is attached to the declaration 310, 311 to form a customs import declaration with lock notice 320 or a customs export declaration with lock notice 321. The notice 320, 321 is sent from the remote-site locking system 32 to the system 1. The system 1 then enables customs inspectors and factory inspectors to respectively process respective series of inspections of the cargo, and then sends a customs inspection result 322 to the remote-site locking system 32. Import cargo checking and export cargo checking are respectively and separately initiated by different systems. The delivery requisition system 33 sends a delivery requisition note 330 to the system 1. The note 330 contains information on content of import cargo, including quantity and categories thereof. The system 1 automatically checks stored data relating to the import cargo, and sends back a cargo receipt message 331 to the delivery requisition system 33. The message 331 contains the results of the check performed by the system 1. The ERP system 34 sends a shipment list 340 to the system 1. The list 340 contains information on content of export cargo, including quantity and categories thereof. The system 1 automatically checks stored data relating to the export cargo, and sends back a cargo sent message 341 to the ERP system 33. The message 341 contains the results of the check performed by the system 1.

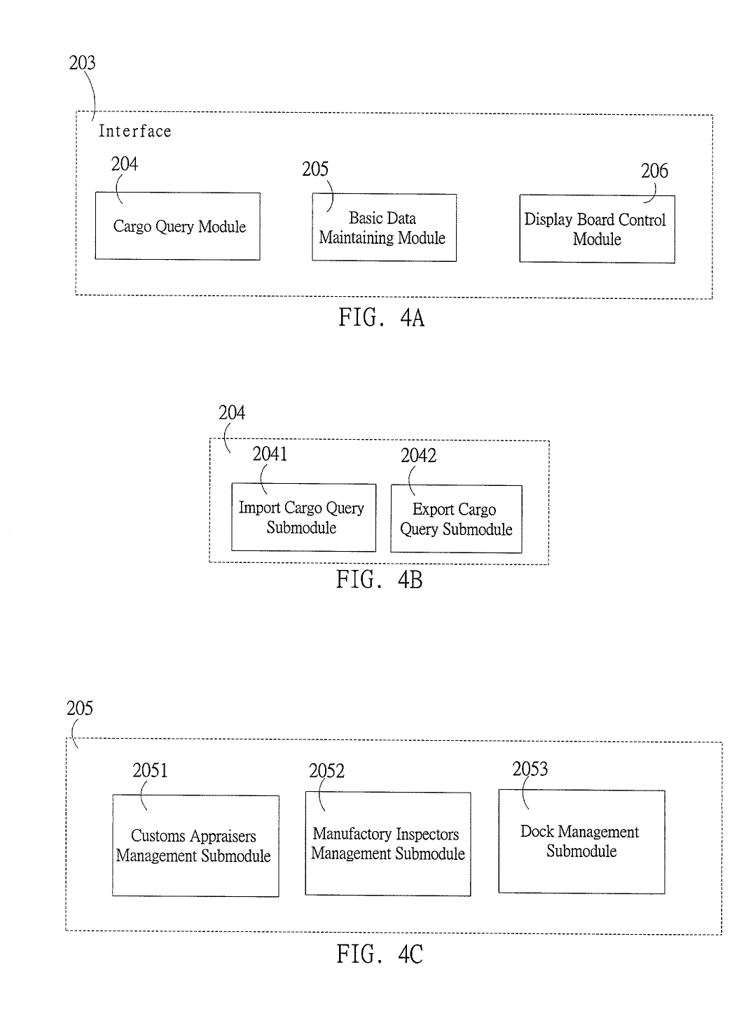

Referring to FIG. 4A, each interactive interface 203 comprises a cargo query module 204 for users who operate the server 10 or the platform computer 20 to check import and export cargo and record the check results, a basic data maintaining module 205 for maintenance of user accounts and passwords, the users' departments' information and cargo loading and unloading dock information, and a display board control module 206 for control of content shown on the display boards 40 (see FIG. 1).

Referring to FIG. 4B, the cargo query module 204 comprises an import cargo query submodule 2041 and an export cargo query submodule 2042. The import cargo query submodule 2041 enables users to query the customs import declaration with lock notice 320 (see FIG. 3) and the delivery requisition note 330 (see FIG. 3), and record the factory check results of import cargo. The export cargo query submodule 2042 enables users to query the customs export declaration with lock notice 321 (see FIG. 3) and the shipment requisition 330 (see FIG. 3), and record the customs inspection results and factory check results of export cargo.

Referring to FIG. 4C, the basic data maintaining module 205 comprises a customs inspectors management submodule 2051, a factory inspectors management submodule 2052 and a dock management submodule 2053. The customs inspectors management submodule 2051 is for managing the customs inspector accounts and passwords. The factory inspectors management submodule 2052 is for managing the factory inspector accounts and passwords. The dock management submodule 2053 enables factory inspectors to order staff on site to either load export cargo or unload import cargo.

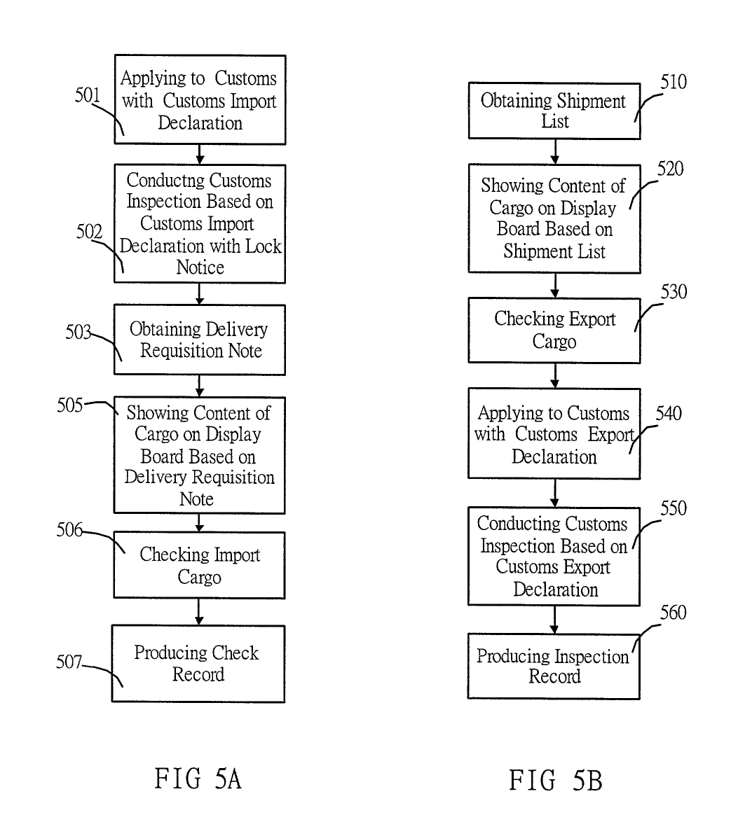

FIG. 5A shows a flowchart of import cargo checking preferably performed by the system 1. The import cargo checking comprises step 501 of applying to customs with a customs import declaration 310 (see FIG. 3) that comprises an application for customs formalities regarding the import cargo, step 502 of conducting a customs inspection of the import cargo based on the customs import declaration with lock notice 320 (see FIG. 3), step 503 of obtaining a delivery requisition note 330 which contains information on content of the import cargo including quantity and categories thereof, step 505 of showing content of the import cargo on the display board 40 based on the delivery requisition note 330, step 506 of checking the import cargo based on the content of the import cargo shown on the display board 40, and step 507 of producing a check record of the results of the customs inspection and the checking of the import cargo.

FIG. 5B shows a flowchart of export cargo checking preferably performed by the system 1. The export cargo checking comprises step 510 of obtaining the shipment list 340 (see FIG. 3) which contains information on content of the export cargo including quantity and categories thereof, step 520 of showing content of the export cargo on the display board 40 based on the shipment list 340, step 530 of checking the export cargo based on the content of the export cargo shown on the display board 40, step 540 of applying to customs with a customs export declaration 311 (FIG. 3) that comprises an application for customs formalities regarding the export cargo, step 550 of conducting a customs inspection of the export cargo based on the customs export declaration with lock notice 321 (see FIG. 3), and step 560 of producing an inspection record of the results of the customs inspection to the export cargo.

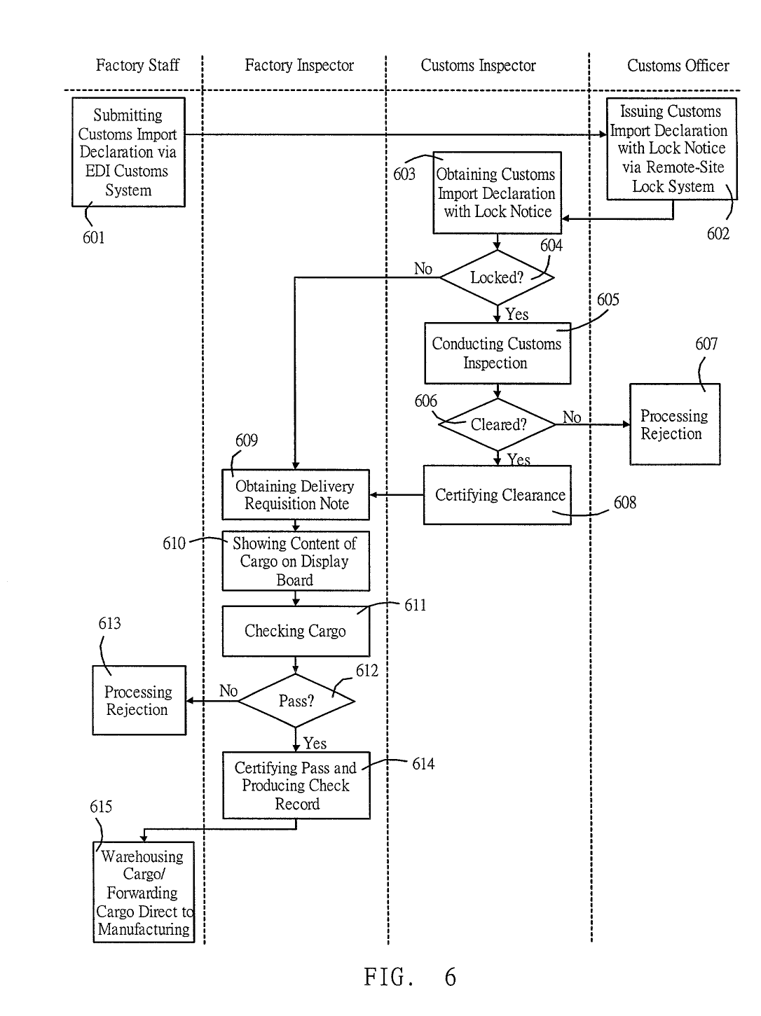

FIG. 6 shows a detailed flowchart of the import cargo checking of FIG. 5A including role players. This is preferably performed by electronic data exchange between the system 1 and the external system 3. There are two role players operating the system 1, being a factory inspector and a customs inspector. There are two role players operating the external system 3, being a factory staff member and a customs officer. The four role players cooperate to perform the detailed import cargo checking. The detailed import cargo checking comprises step 601 of directing the factory staff member to submit a customs import declaration 310 (see FIG. 3) applying for customs formalities via the EDI customs system 31 (see FIG. 2); step 602 of directing the customs officer to issue the customs import declaration with lock notice 320 via the remote-site lock system 32 (see FIG. 2), wherein the lock notice 320 indicates whether or not customs has decided to inspect the cargo; step 603 of directing the customs inspector to obtain the customs import declaration with lock notice 320 (see FIG. 3) by operating the import cargo query submodule 2041 (see FIG. 4B) of the interface 203 (see FIG. 4A) on the platform computer 20 (see FIG. 1); step 604 of finding out whether to conduct inspection according to the lock notice issued in step 602; step 605, if the cargo is locked, of directing the customs inspector to conduct inspection; step 606 of deciding whether the cargo clears the customs inspection; step 607, if the import cargo is not cleared by the customs inspector, of directing the customs officer to process rejection of the import cargo; step 608, if the import cargo is cleared by the customs inspector, of directing the customs inspector to certify clearance by sliding an inspector card through the card reader 202 of the platform computer 20; step 609, if the cargo is cleared or if the cargo is not locked, of directing the factory inspector to operate the import cargo query submodule 2041 (see FIG. 4B) of the interface 203 (see FIG. 4A) to obtain the delivery requisition note 330; step 610 of directing the factory inspector to operate the display board control module 206 (see FIG. 4A) on the platform computer 20 to show information on the import cargo on the display board 40; step 611 of directing the factory inspector to check the import cargo based on the information on the import cargo shown on the display board 40 (see FIG. 1); step 612 of deciding whether the cargo passes the check; step 613, if the import cargo is not passed by the factory inspector, of directing the factory staff member to process rejection; step 614, if the import cargo is passed by the factory inspector, of directing the factory inspector to certify passing of the import cargo check by sliding a card through the card reader 202 and thereby producing a check record in the platform computer 20 recording the import cargo factory check results; and step 615 of directing the factory staff member to warehouse the import cargo or forward the import cargo directly to manufacturing facilities.

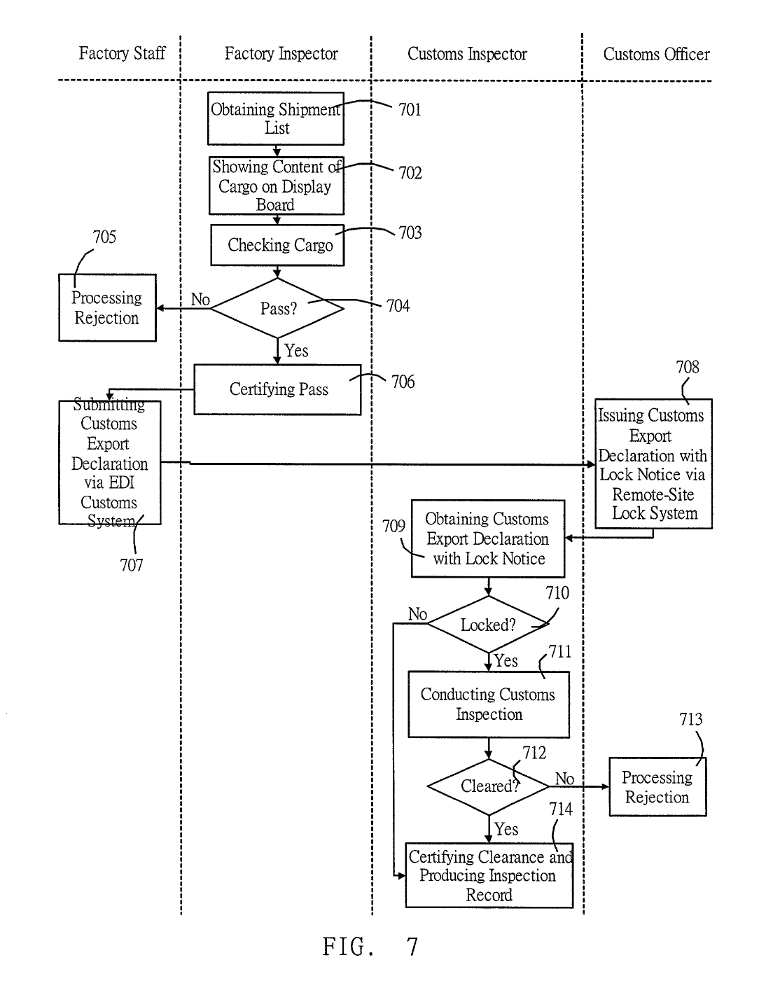

FIG. 7 shows a detailed flowchart of the export cargo checking of FIG. 5B, including role players. This is preferably performed by electronic data exchange between the system 1 and the external system 3. There are two role players operating the system 1, being a factory inspector and a customs inspector. There are two role players operating the external system 3, being a factory staff member and a customs officer. The four role players cooperate to perform the detailed export cargo checking. The detailed export cargo checking comprises step 701 of directing the factory inspector to operate the export cargo query submodule 2041 (see FIG. 4B) of the interface 203 (see FIG. 4A) on the platform computer 20 (see FIG. 1) to obtain the shipment list 340; step 702 of directing the factory inspector to operate the display board control module 206 (see FIG. 4A) on the platform computer 20 to show content of the export cargo on the display board 40; step 703 of directing the factory inspector to check the export cargo based on the content of the export cargo shown on the display board 40; step 704 of deciding whether the cargo passes the check; step 705, if the export cargo is not passed by the factory inspector, of directing the factory staff member to process rejection; step 706, if the export cargo is passed by the factory inspector, of directing the factory inspector to certify passing of the export cargo check by sliding a card through the card reader 202 and thereby producing a check record in the platform computer 20 recording factory check result of the export cargo; step 707 of directing the factory staff member to submit a customs export declaration 311 (see FIG. 3) applying for customs formalities via the EDI customs system 31 (see FIG. 2); step 708 of directing the customs officer to issue the customs export declaration with lock notice 321 (see FIG. 3) via the remote-site lock system 32 (see FIG. 2), wherein the lock notice 321 indicates whether or not customs has decided to inspect the cargo; step 709 of directing the customs inspector to obtain the customs export declaration with lock notice 321 (see FIG. 3) by operating the export cargo query submodule 2042 (see FIG. 4B) of the interface 203 (see FIG. 4A) on the platform computer 20 (FIG. 1); step 710 of finding out whether to conduct cargo inspection according to the lock notice issued in step 707; step 711, if the cargo is locked, of directing the customs inspector to conduct inspection; step 712 of deciding whether the cargo clears the customs inspection; step 713, if the export cargo is not cleared by the customs inspector, of directing the customs officer to process rejection; and step 714, if the export cargo is cleared by the customs inspector, of directing the customs inspector to certify clearance of the export cargo inspection by sliding an inspector card through the card reader 202 of the platform computer 20 and thereby producing an inspection record in the platform computer 20 recording customs inspection result of the export cargo.

The invention has been described in terms of certain preferred embodiments which are representative of only some of the various ways in which the basic concepts of the invention may be implemented, and other implementations of the inventive concepts which may occur to those of ordinary skill in the art are within the scope of the invention and equivalents as defined by the accompanying claims.

What is claimed is:

1. A system for checking import and export cargo and being connected with an external system via a communications network, the system for checking import and export cargo comprising:
a server having a database and an interactive interface for facilitating inspectors in checking import and export cargo, wherein the database stores accounts and passwords of the inspectors, information obtained from the external system, check records of import cargo, and inspection records of export cargo;
a platform computer electrically connected to the server for guiding the inspectors to check import and export cargo;
a serial communication device electrically connected to the platform computer; and
a display board electrically connected to the platform computer via the serial communication device for displaying loading and unloading information on import and export cargo.

2. The system for checking import and export cargo as claimed in claim 1, further comprising a card reader electrically connected to the platform computer for identifying the inspectors.

3. The system for checking import and export cargo as claimed in claim 2, wherein the interactive interface comprises a cargo query module for facilitating users in checking import and export cargo and recording checking results.

4. The system for checking import and export cargo as claimed in claim 3, wherein the interactive interface comprises a basic data maintaining module for facilitating maintenance of user accounts and passwords of users, user department information, and import and export cargo loading and unloading dock information.

5. The system for checking import and export cargo as claimed in claim 4, wherein the interactive interface comprises a display board control module for facilitating control of information shown on the display board.

6. The system for checking import and export cargo as claimed in claim 3, wherein the cargo query module comprises an import cargo query submodule and an export cargo query submodule, the import cargo query submodule facilitating users in querying information on customs import declarations and information on delivery requisitions, and in recording check results of import cargo, the export cargo query submodule facilitating users in querying information on customs export declarations and information on shipment requisitions, and in recording check results of export cargo.

7. A method for checking import cargo, the method comprising the steps of:
(a) applying to customs with a customs import declaration;
(b) conducting a customs inspection based on the customs import declaration;
(c) obtaining a delivery requisition note which contains information on content of the import cargo;
(d) showing content of the import cargo on a display board, the content being based on the delivery requisition note;
(e) checking the import cargo based on the content of the import cargo shown on the display board; and
(f) producing a check record recording check results.

8. The method for checking import cargo as claimed in claim 7, further comprising a step of certifying clearance of the import cargo inspection by sliding a card through a card reader for producing the check record.

9. The method for checking import cargo as claimed in claim 7, further comprising a step of certifying passing of the import cargo check by sliding a card through a card reader for producing the check record.

10. The method for checking export cargo as claimed in claim 7, wherein the check record is produced in a platform computer.

11. A method for checking export cargo, the method comprising the steps of:
(a) obtaining a shipment list which contains information on content of the export cargo;
(b) showing content of the export cargo on a display board, the content being based on the shipment list;
(c) checking the export cargo based on the content of the export cargo shown on the display board;
(d) applying to customs with a customs export declaration;
(e) conducting a customs inspection based on the customs export declaration; and
(f) producing an inspection record for recording inspection results.

12. The method for checking export cargo as claimed in claim 11, further comprising a step of certifying passing of the export cargo check by sliding a card through a card reader.

13. The method for checking export cargo as claimed in claim 11, further comprising a step of certifying clearance of the export cargo inspection by sliding a card through a card reader for producing the inspection record.

14. The method for checking export cargo as claimed in claim 11, wherein the inspection record is produced in a platform computer.

15. An arrangement of importation and exportation using at least four persons including:
a factory staff submitting a customs import/export declaration via EDI customs system, and processing rejection if applicable;
a factory inspector obtaining a delivery requisition note or a shipment list, showing content of a cargo on a display board and checking the cargo;
a customs officer issuing the customs import/export declaration with a lock notice via a remote-site lock system, and processing rejection if applicable; and
a customs inspector obtaining said customs import/export declaration with said lock notice and conducting customs inspection for either rejection or certifying clearance.
